(19) United States
(12) Patent Application Publication
(10) Pub. No.: US 2009/0153469 A1
(43) Pub. Date: Jun. 18, 2009

(54) Input Device and Handheld Electronic Device

(75) Inventors: Ko-Min Wang, Taoyuan City (TW); I-Cheng Chuang, Taoyuan City (TW); Yu-Jing Liao, Taoyuan City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: HTC Corporation, Taoyuan City (TW)

(21) Appl. No.: 12/194,665

(22) Filed: Aug. 20, 2008

(30) Foreign Application Priority Data
Dec. 14, 2007 (TW) 096147934

(51) Int. Cl. G09G 5/00; G06F 1/16

(52) U.S. Cl. 345/156

(57) ABSTRACT

An input device and a handheld electronic device comprising the input device are provided. The input device comprises an elastic sheet and a switch sheet, both with alignment through-holes for precise alignment. Thereby, a protrusion of the elastic sheet is disposed precisely above a switch of the switch sheet. Because of the inerrable assembly of the input device, the handheld electronic device will have an acute response to the depression made by the user.

This application claims priority to Taiwan Patent Application No. 096147934 filed on Dec. 14, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to an input device and a handheld electronic device with the same; and particularly, this invention relates to an input device allowing the internal elements thereof to be precisely aligned and a handheld electronic device with the same.

2. Descriptions of the Related Art

With the prevalence of electronic products, users have had to use various input devices to control these electronic products. Unfortunately, the input devices of many electronic products often fail to respond promptly to the depression made by the user due to the inaccurate internal alignment of the input device. In other words, the user needs to use a large depressing force to get a response from the input device to generate a control signal to the electronic product.

Referring to FIG. 1, the partial cross-sectional view of a conventional handheld electronic device 10 is illustrated. The conventional handheld electronic device 10 includes a key 11, a supporting frame 12, a rubber sheet 13, a dome sheet 14, a circuit board 15, an upper housing 16 and a lower housing 17. The key 11 has a protrusion 111 located in a concave 131 of the rubber sheet 13. The supporting frame 12 is interposed between the key 11 and the rubber sheet 13 to lock both. The dome sheet 14 and the circuit board 15 are directly stacked and bonded together. During the assembly of the handheld electronic device 10, the key 11, the supporting frame 12 and the rubber sheet 13 are assembled in such a way that a protrusion 132 of the rubber sheet 13 is positioned above a switch 142 of the dome sheet 14. Subsequently, the upper housing 16 and the lower housing 17 are assembled to fix and house the aforesaid elements.

In the conventional handheld electronic device 10, the key 11, the protrusion 132 of the rubber sheet 13 and the switch 142 on the dome sheet 14 act as the main elements to actuate the internal circuit. However, the rubber sheet 13 and the dome sheet 14 are at first assembled with some elements respectively before assembling. Because there isn't a way to precisely align the rubber sheet 13 and the dome sheet 14, the protrusion 132 often fails to be disposed precisely above the switch 142. Moreover, slight dimensional variations typically occur to the rubber sheet 13 and the dome sheet 14, especially during a mass production, which further exacerbates the positional offset between the protrusion 132 and the switch 142. If the positional offset amounts to a certain degree, the conventional handheld electronic device 10 would fail to respond promptly to the depression made by the user. The slow response is more likely to cause undesired repeat inputs or an erroneous input.

### SUMMARY OF THE INVENTION

This invention provides an input device which allows the internal elements thereof to be aligned precisely so that a protrusion of the input device is disposed precisely above a switch. As a result, the user can easily depress any key of the input device to actuate the switch.

This invention provides a handheld electronic device comprising such an input device. This handheld electronic device allows the user to input data without applying a large depressing force.

The input device of this invention comprises a switch sheet, an elastic sheet and a cover. The switch sheet has at least one first alignment through-hole and at least one switch. The elastic sheet has at least one second alignment through-hole and at least one protrusion. The switch sheet is disposed beneath the elastic sheet in such a way so the first alignment through-hole and the second alignment through-hole are overlapped with each other to position the protrusion above the switch precisely. The cover is disposed on the elastic sheet to receive the depression made by the user and transmit the depressing force to the protrusion for actuating the switch to generate an electrical signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a partial cross-sectional view of a conventional input device;

FIG. 2A is an assembled view of an input device in accordance with an embodiment of this invention;

FIG. 2B is an exploded view of an input device in accordance with an embodiment of this invention;

FIG. 3 is a cross-sectional view of the input device along line A-A in FIG. 2A;

FIG. 4 is a flow diagram of the process for assembling an input device of an embodiment of this invention;

FIG. 5A is an exploded view of a handheld electronic device of this invention; and

FIG. 5B is an assembled view of the handheld electronic device of this invention.

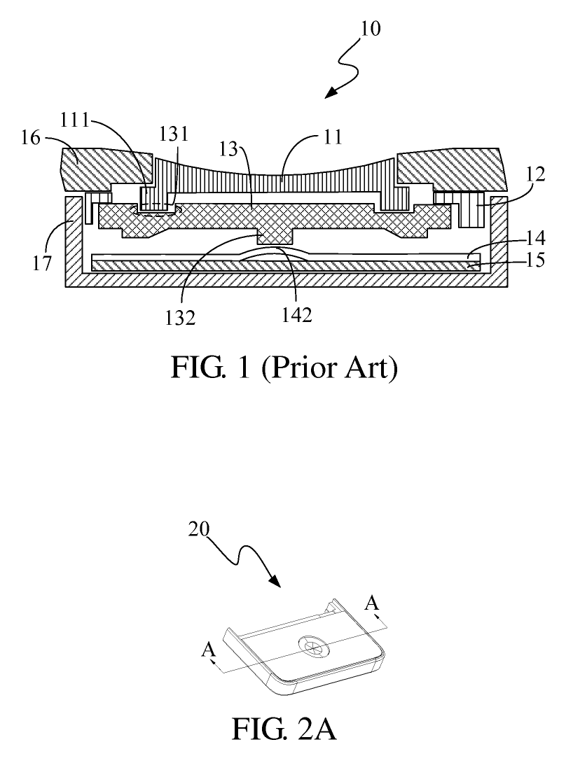

### DESCRIPTION OF THE PREFERRED EMBODIMENT

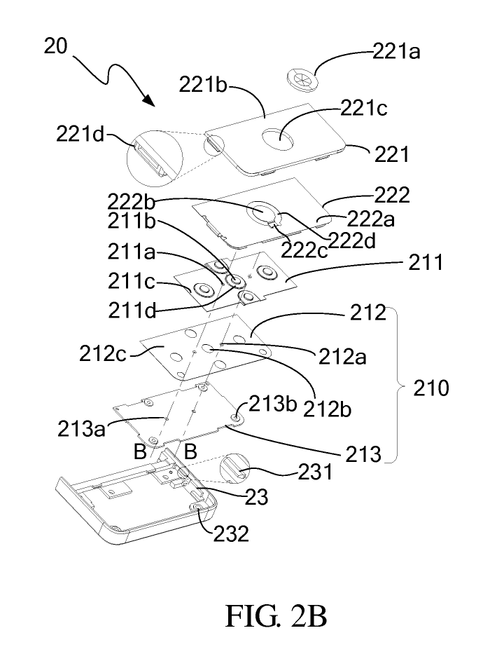

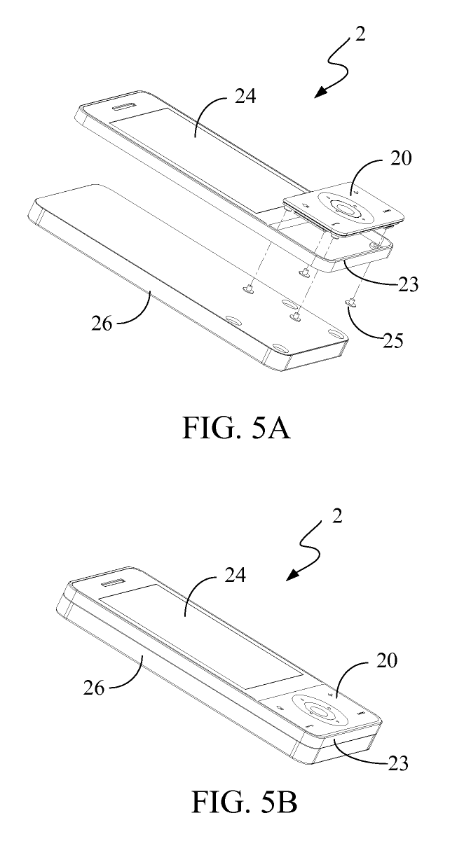

An embodiment of this invention is a handheld electronic device. In this embodiment, the handheld electronic device may be a mobile phone, a personal digital assistant (PDA) or a pocket PC. An exploded view and an assembled view of the handheld electronic device are depicted respectively in FIG. 5A and FIG. 5B. The handheld electronic device 2 includes an input device 20, an upper housing 23, a display unit 24, a plurality of screws 25 and a lower housing 26. An assembled view and an exploded view of the input device 20 are depicted respectively in FIG. 2A and FIG. 2B. The input device 20 can be assembled precisely before being assembled with the upper housing 23. As a result, the user can input data correctly via the input device 20 to display the data in the display unit 24.

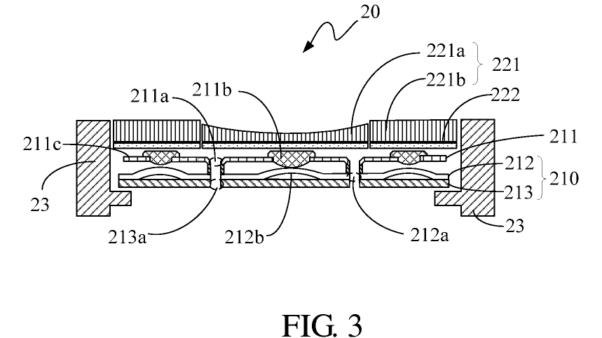

Refer to FIG. 2A, FIG. 2B and FIG. 3. FIG. 3 is a cross-sectional view of the input device 20 taken along line A-A in FIG. 2A. The input device 20 comprises a switch sheet 210, an elastic sheet 211, a cover 221 and a sensor circuit board 222.

In this embodiment, the switch sheet 210 includes a dome sheet 212 and a circuit board 213 disposed beneath the dome sheet 212. The dome sheet 212 has a pair of first alignment through-holes 212a, five switches 212b and a plastic sheet 212c. In this embodiment, the switch 212b may be a metal dome switch or a polymer dome switch, and is formed integrally with the plastic sheet 212c. Furthermore, the pair of first alignment through-holes 212a are formed through the plastic sheet 212c of the dome sheet 212, and a pair of first alignment through-holes 213a are formed through the circuit board 213. In other words, the switch sheet 210 has multiple alignment through-holes. More specifically, the first alignment through-holes 212a of the dome sheet 212 and the first alignment through-holes 213a of the circuit board 213 are sequentially overlapped and aligned with each other. Therefore, with the pair of first alignment through-holes 212a of the dome sheet 212 and the pair of first alignment through-holes 213a of the circuit board 213, the dome sheet 212 can be aligned with and bonded to the circuit board 213. However, in other embodiments, the switch sheet 210 of this invention may be substituted by a membrane circuit sheet or other forms of circuit boards.

The elastic sheet 211 is disposed above the dome sheet 212 of the switch sheet 210. In this embodiment, the elastic sheet 211 has five protrusions 211b, five cantilevers 211d and a connecting portion 211c, in which the five protrusions 211b protrude towards the five switches 212b of the dome sheet 212 respectively. The cantilevers 211d are respectively connected to the protrusions 211b, and the connecting portion 211c is in turn connected to the cantilevers 211d. Furthermore, the connecting portion 211c has a pair of second alignment through-holes 211a. The first alignment through-holes 212a, 213a are aligned with the same number of corresponding second alignment through-holes 211a respectively to precisely position the switch sheet 210 and the elastic sheet 211 and also accurately position the protrusions 211b above the corresponding switches 212b of the dome sheet 212. In other embodiments, other applicable numbers of the protrusions, the cantilevers and the switches will readily occur to those skilled in the art.

In this embodiment, the protrusions 211b are made of a material different from those of the cantilevers 211d and the connecting portion 211c. For example, the protrusions 211b may be made of a rubber material, while the connecting portion 211 and the cantilevers 211d may be made of polyethylene terephthalate (PET). Additionally, the protrusions 211b, the connecting portion 211c and the cantilevers 211d are co-molded through an in-mold film decoration (IMF decoration) process. The cantilevers 211d are preferably circular cantilevers. The protrusions 211b are adapted to be located at the center of the circular cantilevers. However, the cantilevers 211d may also be formed into other shapes. Although there is one pair of alignment through-holes in each respective sheet in this embodiment, there may be more or less second alignment through-holes, first alignment through-holes of the dome sheet or first alignment through-holes of the circuit board. These components may also have a non-axisymmetric or an axisymmetric shape. For example, in other embodiments, there may be only one second alignment through-hole, one first alignment through-hole of the dome sheet and one first alignment through-hole of the circuit board, with each one having a non-axisymmetric shape. This may simplify the alignment process for aligning the second alignment through-hole, the first alignment through-hole of the dome sheet and the first alignment through-hole of the circuit board with each other.

The cover 221 is disposed above the elastic sheet 211, with the sensor circuit board 222 interposed therebetween. More specifically, in this embodiment, the cover 221 includes a key cap 221a and a key pad 221b. The key pad 221b has a first opening 221c, into which the key cap 221a is located. Additionally, the sensor circuit board 222 includes a first portion 222a, a second portion 222b, and a connecting portion 222c connected to the first portion 222a and the second portion 222b respectively. The first portion 222a of the sensor circuit board 222 has a second opening 222d. The second portion 222b is located in the second opening 222d and corresponds to the key cap 222d. Preferably, the sensor circuit board 222 is a flexible printed circuit board (FPCB), and may be a capacitive sensor circuit board or a thermal sensor circuit board. In other examples, the cover 221 may be comprised of a single member without the key cap 221a. Furthermore, if the input device 20 is not provided with a touch sensing function, the sensor circuit board 222 may be eliminated in this embodiment.

The key pad 221a and the key cap 221b of the cover 221 both have a depressing area disposed above the plurality of protrusions 211b and the plurality of switches 212b. When the depressing area of the cover 221 is depressed, the cover 221 is pressed against the elastic sheet 211, causing the protrusion 211b to press the switch 212b of the dome sheet 212. In response to this, the switch 212b collapses and contacts an electric contact on the circuit board 213 to generate an electrical signal. Additionally, the sensor circuit board 222 is configured to sense the touch action on the depressing area. By using the sensor circuit board 222 and the dome sheet 212, the handheld electronic device 2 of this invention is not only able to sense the movement of the user's finger on the depression area, but may also provide the user with a touch response like a keyboard for the user to confirm the completion of command inputting action.

Preferably, the key pad 221b of the cover 221 has a number of first locking portions 221d, while the upper housing 23 of the handheld electronic device 2 has the same number of second locking portions 231. The first locking portions 221d are adapted to lock the second locking portions 231 to constrain the displacement of the cover 221.

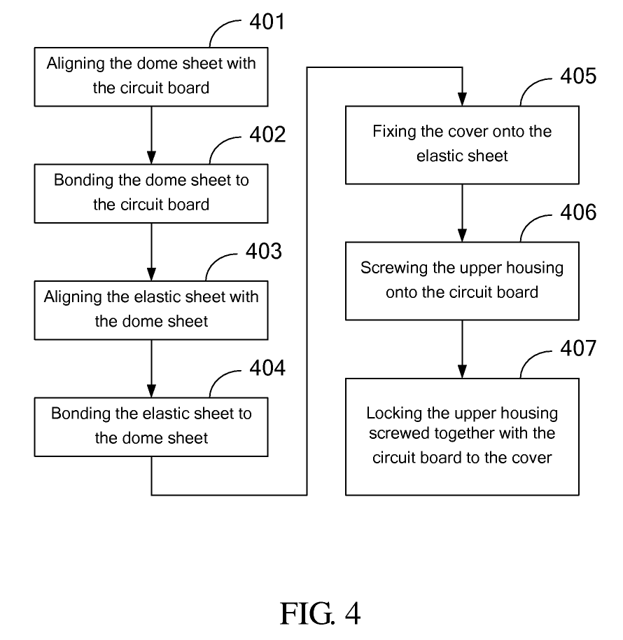

By using the first alignment through-holes 212a and the second alignment through-holes 211a described above, the protrusions 211a and the switches 212b can be aligned more precisely with each other during the assembling process of the input device 20. As shown in FIG. 2B and the flow diagram shown in FIG. 4, the assembly process comprises the following steps.

Initially in Step 401, the two first alignment through-holes 213a of the circuit board 213 are aligned with the two first alignment through-holes 212a of the dome sheet 212 along the two aligning lines B to align the dome sheet 212 with the circuit board 213. In Step 402, the dome sheet 212 is bonded to the circuit board 213 to complete the assembly of the switch sheet 210. In Step 403, the two second alignment through-holes 211a of the elastic sheet 211 are aligned with the two first alignment through-holes 212a of the dome sheet 212 along the two aligning lines B shown in FIG. 2 to align the elastic sheet 211 with the dome sheet 212. After Step 403, in Step 404, the elastic sheet 211 is bonded to the dome sheet 212 of the switch sheet 210.

Subsequent to the assembly of the aforesaid elements, the cover 221 is fixed onto the elastic sheet 211 in Step 405. If the input device 20 has a sensor circuit board 222, the cover 221 should be bonded to the sensor circuit board 222 before being fixed onto the elastic sheet 211. In Step 406, the upper housing 23 that is used for accommodating the input device 20 in the handheld electronic device 2 is joined with the circuit board 213 with screws. Finally, in Step 407, the second locking portions 231 of the upper housing 23 are locked with the first locking portions 221d of the cover 221, thus completing the assembly of the input device 20 of the handheld electronic device 2.

As mentioned above and depicted in the exploded view of FIG. 5A and the assembled view of FIG. 5B, the handheld electronic device 2 of this embodiment includes the input device 20, the upper housing 23, the display unit 24, a plurality of screws 25 and the lower housing 26. The display unit 24 has a display area, and is assembled to the upper housing 23 with the display area being shown therethrough. Also shown in FIG. 2B, the input device 20 of this invention is assembled to the upper housing 23 with a plurality of screws 25, which are inserted through a plurality of holes 232 in the upper housing 23 and screwed into a plurality of threaded holes 213b in the circuit board 213. Upon completion of the assembly of the input device 20 and the upper housing 23, the lower housing 26 of the handheld electronic device 2 is assembled to the upper housing 23, thus completing the assembly of the handheld electronic device 2, as depicted in FIG. 5.

This invention simplifies the assembly process by replacing the supporting frames and the rubber sheet in the prior art solutions with an elastic sheet. Moreover, the alignment through-holes are provided in the elastic sheet and the dome sheet to allow the precise alignment of the elastic sheet with the dome sheet, so that the protrusions are positioned accurately above the corresponding switches. As a result, the handheld electronic device adopting the input device of this invention demonstrates a significantly improved response speed, and the user can expect a response from the handheld electronic device without having to apply a large pressing force on the input device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An input device, adapted to be assembled to an upper housing of a handheld electronic device, comprising:
a switch sheet having at least one first alignment through-hole and at least one switch;
an elastic sheet, disposed on the switch sheet, comprising:
at least one protrusion oriented toward the at least one switch;.
at least one cantilever connected to the at least one protrusion;
a connecting portion, connected to the at least one cantilever and bonded to the switch sheet, the connecting portion having at least one second alignment through-hole, wherein the at least one first alignment through-hole and the at least one second alignment through-hole are overlapped with each other; and
a cover disposed on the elastic sheet, wherein when being depressed, the cover abuts the elastic sheet to force the at least one protrusion to depress the at least one switch.

2. The input device as claimed in claim 1, wherein the switch sheet comprises:
a circuit board; and
a dome sheet, bonded to the circuit board and having the at least one switch, wherein the at least one first alignment through-hole passing through the circuit board and the dome sheet.

3. The input device as claimed in claim 2, wherein the dome sheet further comprises a plastic sheet, the at least one first alignment through-hole passes through the plastic sheet, and the at least one switch and the plastic sheet are integrated.

4. The input device as claimed in claim 1, wherein the switch sheet is a membrane circuit sheet.

5. The input device as claimed in claim 1, further comprising a sensor circuit board disposed under the cover, wherein the sensor circuit board is adapted to sense a touching action.

6. The input device as claimed in claim 5, wherein the sensor circuit board is a capacitive sensor circuit board or a thermal sensor circuit board.

7. The input device as claimed in claim 5, wherein the sensor circuit board comprises:
a first portion having a second hole;
a second portion located in the second hole; and
a connecting portion connecting the first portion and the second portion.

8. The input device as claimed in claim 7, wherein the cover comprises a key pad and a key cap, the key pad has a first hole, and the key cap is located in the first hole and corresponding to the second portion.

9. The input device as claimed in claim 1, wherein the cover has a plurality of first locking portions, the upper housing has a plurality of second locking portions, and the first locking portions are adapted to lock with the second locking portions to constrain the displacement of the cover.

10. The input device as claimed in claim 1, wherein the material of the at least one protrusion differs from the material of the at least one cantilever and the connecting portion.

11. The input device as claimed in claim 10, wherein the at least one cantilever and the connecting portion are made of a same material, and the material of the at least one protrusion is rubber.

12. The input device as claimed in claim 11, wherein the material of the at least one cantilever and the connecting portion is Polyethylene Terephthalate (PET).

13. The input device as claimed in claim 1, wherein the at least one cantilever comprises a circular cantilever, and the at least one protrusion is located at a center of the circular cantilever.

14. A handheld electronic device, comprising:
an upper housing;
a display unit assembled to the upper housing and having a display area, the upper housing showing the display area; and
an input device as claimed in claim 1 assembled to the upper housing.

15. The handheld electronic device as claimed in claim 14, further comprising a lower housing assembled with the upper housing.
